(19) United States
(12) Patent Application Publication
(10) Pub. No.: US 2022/0278366 A1
(43) Pub. Date: Sep. 1, 2022

(54) HYBRID COMPOSITE ELECTROLYTE COMPRISING A FLUOROPOLYMER

(71) Applicant: SOLVAY SPECIALTY POLYMERS ITALY S.P.A., Bollate (IT)

(72) Inventors: Maurizio BISO, Milano (IT); Francesco LIBERALE, Pavia (IT); Vincent FINSY, Halle (BE); Luca MERLO, Ixelles (BE)

(21) Appl. No.: 17/637,466

(22) PCT Filed: Aug. 31, 2020
(86) PCT No.: PCT/EP2020/074174

§ 371 Date: Feb. 23, 2022

(30) Foreign Application Priority Data
Sep. 2, 2019 (EP) 19194856.1

(51) Int. Cl. H01M 10/0565; H01M 10/0562; H01M 10/052; H01M 4/04; H01M 4/139

(52) U.S. Cl. CPC H01M 10/0565; H01M 10/0562; H01M 10/052; H01M 4/0404; H01M 4/139; H01M 2300/0068; H01M 2300/0082; H01M 2300/0088

(57) ABSTRACT

The present invention relates to a solid electrolyte film comprising sulfide-based solid electrolyte particles dispersed into an amorphous fluorinated binder, said solid electrolyte film being characterized by improved ionic conductivity, improved resistance to oxidation and good mechanical properties. The invention further relates to a process for the manufacture of said solid electrolyte film and to its use in solid state batteries.

### CROSS-REFERENCE TO RELATED APPLICATIONS

This application claims priority to European application No. 19194856.1 filed on Sep. 2, 2019, the whole content of this application being incorporated herein by reference for all purposes.

### TECHNICAL FIELD

The present invention relates to a solid electrolyte film comprising sulfide-based solid electrolyte particles dispersed into an amorphous fluorinated binder, said solid electrolyte film being characterized by improved ionic conductivity, improved chemical resistance and good mechanical properties. The invention further relates to a process for the manufacture of said solid electrolyte film and to its use in solid state batteries.

### BACKGROUND ART

For more than two decades Li-ion batteries have dominated the market of rechargeable energy storage devices due to their light weight, reasonable energy density and good cycle life. Nevertheless, current Li-ion batteries suffer from poor safety and too low energy density required for high power applications such as electrical vehicles (EV), hybrid electrical vehicles (HEV) and grid energy storage. It is the presence of liquid electrolyte that is at the basis of these shortcomings. Conventional Li-ion battery liquid electrolytes are based on organic carbonates that undergo leakage, generate volatile gaseous species and are flammable.

Solid state batteries (SSB) are believed to be the next generation of energy storage devices as they provide higher energy density and are safer. In a SSB the highly flammable liquid electrolyte is replaced by a solid electrolyte, removing virtually all risk of ignition and/or explosion.

Three types of solid electrolytes exist: inorganic, polymeric and composite solid electrolytes.

Inorganic electrolytes such as sulfide Li conductive materials have high ionic conductivity, but poor mechanical properties. These materials rely on high pressure densification processes. Thin film formability by pressing has yet to be demonstrated, hindering mass-production at commercial scales.

Polymer electrolytes have good mechanical properties and processability, but suffer from low ionic conductivity.

Composite electrolytes, composed of solid inorganic ionic (Li⁺) conductor particles (SICs) dispersed into a polymeric matrix, offer the possibility to combine high ionic conductivity with good mechanical properties.

Sulfide solid electrolyte materials are known to be used as the solid particles in composite electrolytes, having high Li ion conductivity, useful to achieve a higher output of the battery.

For example, in JP2010-212058, Li₂S-P₂S₅ sulfide electrolyte material mixed with a silicon polymer binder is used to prepare the solid electrolyte layer of a solid lithium secondary battery.

State of the art composite electrolytes are usually produced through a wet casting method. In this method, the SIC powder is dispersed into a solution of the binder in a solvent to form a slurry which is cast on a support and subsequently dried to remove the used solvent.

However, sulfide solid electrolytes show very poor solvent compatibility, limiting the number of binders that can be used. As a result, state of the art sulfide based composite electrolytes use non conductive, preferentially hydrogenated binders. In addition, since the binder has to be dissolved in a solvent to form the slurry, using a non conductive binder leads to the formation of an isolating layer on top of the sulfide solid electrolyte particles, resulting in a significant reduction of the ionic conductivity in the composites.

Although some reports suggest the use of fluorinated binders for sulfide composites, typical fluorinated binders cannot be solubilized in solvents compatible with sulfides.

EP3467846 and JP2017-157300 disclose composite solid electrolytes comprising lithium-phosphorus-sulfide glass particles dispersed in a fluorinated binder, said particles being prepared from a liquid composition comprising the two ingredients together with a hydrocarbon solvent.

CN109786845 discloses a hybrid electrolyte composition comprising sulfide-based glass and a fluoropolymer, the fluoropolymer being a semi-crystalline vinylidene fluoride (VDF)/hexafluoropropylene (HFP), said composite being prepared from liquid compositions based on a hydrocarbon solvent.

Also Proceedings of the National Academy of Sciences, vol 113, pages 52-57, 2015 discloses a hybrid electrolyte compositions, said composition comprising sulfide-based glass and a PFPE fluoropolymer; the composition is prepared through a dry method.

As such, there is a large need for non conductive binders for sulfide solid electrolyte that have a low negative impact on the ionic conductivity of the resulting composite electrolyte, are characterized by an improved resistance to oxidation and that can be used in the manufacture of solid electrolyte layers through fabrication processes compatible with sulfides.

### SUMMARY OF INVENTION

The Applicant has now surprisingly found that, by the use of an amorphous (per)fluorinated polymer as binder in a classical wet casting method, the negative impact of the binder on the ionic conductivity is reduced to a large extent. The ionic conductivity of composite solid electrolytes including amorphous perfluorinated binders is much higher compared to composite electrolytes with the same volume percentage of hydrogenated polymers.

It is thus an object of the invention a composite solid electrolyte film for solid state batteries comprising:

i) at least one sulfide-based solid electrolyte; and

ii) at least one (per)fluorinated amorphous polymer [polymer (A)].

In another object, the present invention provides a composition (C) that is suitable for preparing the composite solid electrolyte film as above defined, said composition comprising:

i) at least one sulfide-based solid electrolyte;

ii) at least one (per)fluorinated amorphous polymer [polymer (A)]; and

iii) at least one (per)fluorinated solvent (S).

A further object of the invention is thus a process for manufacturing a composite solid electrolyte film for solid state batteries comprising the steps of:

I) processing the composition (C) as above defined to form a wet film of a solid composite electrolyte; and

II) drying the wet film provided in step (I).

Composition (C) is also suitable for use in the preparation of electrodes for solid state batteries.

A further object of the invention is thus a process for manufacturing an electrode for solid state battery comprising the steps of:

A) providing an electrode-forming composition comprising:

a composition (C) as above defined;

at least one electrode active material (AM); and

optionally, at least one electrical conductive additive;

B) providing a metal substrate having at least one surface;

C) applying the electrode-forming composition provided in step A) onto the at least one surface of the metal substrate provided in step B), thereby providing an assembly comprising a metal substrate coated with said composition (C) onto the at least one surface;

D) drying the assembly provided in step C).

In another object, the present invention provides an electrode for a solid state battery obtainable by the process as above defined.

In still a further object, the present invention provides a solid state battery comprising a composite solid electrolyte film and/or at least one electrode of the present invention.

### BRIEF DESCRIPTION OF DRAWINGS

FIG. 1 shows a cross-section of the pressure cell in AC impedance spectroscopy, developed within Solvay to measure the ionic conductivity of the film. In the pressure cell, the film is pressed between 2 stainless steel electrodes during impedance measurement.

### DETAILED DESCRIPTION

As used within the present description and in the following claims, the use of parentheses around symbols or numbers identifying the formulae, for example in expressions like “polymer (P)”, etc., has the mere purpose of better distinguishing the symbol or number from the rest of the text and, hence, said parenthesis can also be omitted.

In the context of the present invention, the term “percent by weight” (wt %) indicates the content of a specific component in a mixture, calculated as the ratio between the weight of the component and the total weight of the mixture. When referred to the recurring units derived from a certain monomer in a polymer/copolymer, percent by weight (wt %) indicates the ratio between the weight of the recurring units of such monomer over the total weight of the polymer/copolymer.

In the present invention, the term “composite solid electrolyte film” refers to a composite film having lithium ionic conductivity, which has a free-standing shape at room temperature without a support, and may be in the form of a foldable, flexible and self-standing film. The composite solid electrolyte film according to the present invention does neither flow to take on the shape of its container, nor does it expand to fill the entire volume available. On the other hand, the composite solid electrolyte film according to the present invention may be shaped in a variety of manner due to its flexibility and hence may accommodate a change in either volume or shape which may happen during charging and discharging of a lithium battery.

As used here, the phrase “sulfide-based solid electrolyte,” refers to an inorganic solid state material that conducts Li+ ions but is substantially electronically insulating.

In the present invention, the term “sulfide-based solid ionic conducting inorganic particle” is not particularly limited as long as it is a solid electrolyte material containing sulfur atom(s) in the molecular structure or in the composition.

The sulfide-based solid ionic conducting inorganic particle preferably contains Li, X (with X being P, Si, Sn, Ge, Al, As, or B) and S, to increase Li-ion conductivity.

The sulfide-based solid ionic conducting inorganic particle according to the present invention is more preferably selected from the group consisting of:

lithium tin phosphorus sulfide (“LSPS”) materials, such as Li₁₀SnP₂S₁₂;

lithium phosphorus sulfide (“LPS”) materials, such as glasses, crystalline or glass-ceramic of those of formula (Li₂S)ₓ—(P₂S₅)_{y}, wherein x+y=1 and 0≤x≤1, Li₇P₃S₁₁, Li₇PS_{6,} Li₄P₂S₆, Li_{9.6}P₃S₁₂and Li₃PS₄;

doped LPS, such as Li₂CuPS₄, Li₁₊₂ₓZn₁₋ₓPS₄, wherein 0≤x≤1, Li_{3.33}Mgo_{0.33}P₂S₆, and Li₄₋₃ₓScₓP₂S₆, wherein 0≤x≤1;

lithium phosphorus sulfide oxygen (“LPSO”) materials of formula LixPySzO, where 0.33≤x≤0.67, 0.07≤y≤0.2, 0.4≤z≤0.55, 0≤w≤0.15;

lithium phosphorus sulfide materials including X (“LXPS”), wherein X is Si, Ge, Sn, As, Al, such as Li₁₀GeP₂S₁₂ and Li₁₀SiP₂S₁₂;

lithium phosphorus sulfide oxygen including X (“LXPSO”), wherein X is Si, Ge, Sn, As, Al;

lithium silicon sulfide (“LSS”) materials;

lithium boron sulfide materials, such as Li₃BS₃ and Li₂S—B₂S₃—Lil;

lithium tin sulfide materials and lithium arsenide materials, such as Li_{0.8}Sn_{0.8}S₂, Li₄SnS₄, Li_{3.833}Sn_{0.833}AS_{0.166}S₄, Li₃AsS₄-Li₄SnS₄, Ge-substituted Li₃AsS₄; and

Argyrodite-type sulfide materials of formula Li₆PS₅Y, wherein Y is CI, Br or I , the compounds being possibly deficient in sulfur, lithium or halogen, for instance Li₆₋ₓPS₅₋ₓCl₁₊ₓ with 0≤x≤0.5, or doped with a heteroatom.

Particularly preferred sulfide solid electrolytes are lithium tin phosphorus sulfide (“LSPS”) materials (e.g., Li₁₀SnP₂S₁₂) and Argyrodite-type sulfide materials (e.g., Li₆PS₅Cl).

The (per)fluorinated amorphous polymers (A) of the present invention are typically selected from the group consisting of:

polymers (A-1) comprising recurring units derived from:

perfluorodioxoles of formula (I):

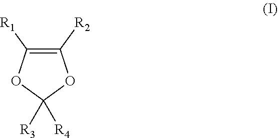

wherein R₁, R₂, R₃ and R₄, equal to or different from each other, are independently selected from the group consisting of —F, a C₁-C₆ fluoroalkyl group, optionally comprising one or more oxygen atoms;

at least one fluorinated monomer selected from the group consisting of:

C₂-C₈ perfluoroolefins such as tetrafluoroethylene (TFE) and hexafluoropropylene (HFP);

C₂-C₈ hydrogenated fluoroolefins such as vinyl fluoride (VF1), 1,2-difluoroethylene and trifluoroethylene (VF3); and

chloro- and/or bromo- and/or iodo-C₂-C₆ fluoroolefins such as chlorotrifluoroethylene (CTFE);

polymers (A-2) comprising recurring units derived from:

C₂-C₈ perfluoroolefins such as tetrafluoroethylene (TFE) and hexafluoropropylene (HFP);

at least one fluorinated monomer selected from the group consisting of:

perfluoroalkylvinylethers of formula CF₂=CFOR_{f1′} wherein R_{f1′} is a C₁-C₆ perfluoroalkyl group;

perfluoro-oxyalkylvinylethers of formula CF₂=CFOX₀ wherein X₀ is a C₁-C₁₂ perfluorooxyalkyl group comprising one or more ether groups, such as perfluoro-2-propoxy-propyl group; and

optionally, recurring units derived from C₂-C₈ hydrogenated fluoroolefins such as vinyl fluoride (VF1), 1,2-difluoroethylene and trifluoroethylene (VF3);

polymers (A-3) comprising recurring units derived from at least one cyclopolymerizable monomer of formula

CR₅R₆=CR₇OCR₈R₉(CR₁ₒR₁₁)ₐ(O)_{b}CR₁₂=CR₁₃R₁₄, wherein each R₅ to R₁₄, independently of one another, is selected from —F and a C₁-c₃ fluoroalkyl group, a is 0 or 1, b is 0 or 1 with the proviso that b is 0 when a is 1;

polymers (A-4) comprising:
recurring units derived from C₂-C₈ perfluoroolefins such as tetrafluoroethylene (TFE) and hexafluoropropylene (HFP); and
   recurring units derived from C₂-C₈ hydrogenated fluoroolefins such as vinylidene fluoride (VDF), vinyl fluoride (VF1), 1,2-difluoroethylene and trifluoroethylene (VF3).

The polymers (A-1) are more preferably selected from the group consisting of recurring units derived from at least one perfluorodioxole of formula (I):

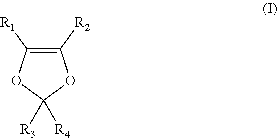

wherein R₁, R₂, R₃ and R₄, equal to or different from each other, are independently selected from the group consisting of —F, a C₁-C₃ perfluoroalkyl group, e.g. —CF₃, -C₂F₅, -C₃F₇, and a C₁-C₃ perfluoroalkoxy group optionally comprising one oxygen atom, e.g. —OCF₃, —OCF₅, —OC₃F₇, —OCF₂CF₂OCF₃; preferably, wherein R₁=R₂=—F and R₃=R₄ is a C₁-C₃ perfluoroalkyl group, preferably R₃=R₄=−CF₃ or wherein R₁=R₃=R₄=—F and R₂ is a C₁-C₃ perfluoroalkoxy, e.g. —OCF₃, —OC₂F₅, −OC₃F₇, and tetrafluoroethylene (TFE).

The polymer (A-1) more preferably comprises recurring units derived from at least one perfluorodioxole of formula (I) as defined above wherein R₁=R₃=R₄=—F and R₂=—OCF₃ or wherein R₁=R₂=—F and R₃=R₄=—CF₃ and recurring units derived from tetrafluoroethylene (TFE).

Non-limitative examples of suitable polymers (A-1) include, notably, those commercially available under the trademark name HYFLON® AD from Solvay Specialty Polymers Italy S.p.A. and TEFLON® AF from E. I. Du Pont de Nemours and Co.

The polymer (A-2) preferably comprises recurring units derived from tetrafluoroethylene (TFE) and at least 1.5% by weight, preferably at least 5% by weight, more preferably at least 7% by weight of recurring units derived from at least one fluorinated monomer different from TFE.

The polymer (A-2) preferably comprises recurring units derived from tetrafluoroethylene (TFE) and at most 30% by weight, preferably at most 25% by weight, more preferably at most 20% by weight of recurring units derived from at least one fluorinated monomer different from TFE.

Non-limitative examples of suitable polymers (A-2) include, notably, those commercially available under the trademark name HYFLON® PFA P and M series and HYFLON® MFA from Solvay Specialty Polymers Italy S.p.A.

Suitable polymers (A-2) are also the polymers including: recurring units derived from tetrafluoroethylene (TFE), recurring units derived from at least one perfluoroalkylvinylether selected from the group consisting of perfluoromethylvinylether of formula CF₂=CFOCF₃, perfluoroethylvinylether of formula CF₂=CFOC₂F₅ and perfluoropropylvinylether of formula CF₂=CFOC₃F₇, and recurring units derived from at least one C₂-C₈ hydrogenated fluoroolefin. Particularly suitable polymers (A-2) are polymers including recurring units derived from tetrafluoroethylene (TFE), recurring units derived from perfluoromethylvinylether of formula CF₂=CFOCF₃, and recurring units derived from vinylidene fluoride (VDF).

The polymer (A-2) more preferably comprises recurring units derived from tetrafluoroethylene (TFE), recurring units derived from hexafluoropropene (HFP) and recurring units derived from vinylidene fluoride (VDF).

The polymer (A-3) preferably comprises recurring units derived from at least one cyclopolymerizable monomer of formula CR₇R₈=CR₉OCR₁₀R₁₁(CR₁₂R₁₃)ₐ(O)_{b}CR₁₄=CR₁₅R₁₆, wherein each R₇ to R₁₆, independently of one another, is —F, a=1 and b=0.

Non-limitative examples of suitable polymers (A-3) include, notably, those commercially available under the trademark name CYTOP® from Asahi Glass Company.

The polymers (A-4) preferably comprise recurring units derived from vinylidene fluoride (VDF) and recurring units derived from at least one C₃-C₈ perfluoroolefins, such as hexafluoropropene (HFP).

Non-limitative examples of suitable polymers (A-4) include, notably, those commercially available under the trademark name TECNOFLON® FKM from Solvay Specialty Polymers Italy S.p.A.

The polymer (A) is typically manufactured by suspension or emulsion polymerization processes.

The amount of one or more comonomers in polymers (A-1), (A-2), (A-3) and (A-4) is to be such to bring to amorphous (per)fluorinated polymers. Those of ordinary skill in the field are able to easily determine the amount of such comonomers.

The perfluorodioxoles class having structure (I) preferably used in the present invention are mentioned in EP 633256; still more preferably 2,2,4-trifluoro-5-trifluoromethoxy-1,3-dioxole (TTD) is used.

The term “amorphous” is hereby intended to denote a polymer (A) having a heat of fusion of less than 5 J/g, preferably of less than 3 J/g, more preferably of less than 2 J/g as measured by Differential Scanning Calorimetry (DSC) at a heating rate of 10° C/min according to ASTM D-3418-08.

The composite solid electrolyte film of the invention is characterized by a high ionic conductivity, despite the polymer (A) is non-conductive. Without wishing to be bound by any theory, the inventors believe that the limited negative impact on the ionic conductivity is to be attributed to the amorphous character of the (per)fluorinated polymer (A) in the solid electrolyte film.

Composition (C), suitable for preparing a composite solid electrolyte film as above defined, comprises:
i) at least one sulfide-based solid electrolyte as above defined;
ii) at least one (per)fluorinated amorphous polymer [polymer (A)] as above defined; and
iii) at least one (per)fluorinated solvent (S).

The solvent (S) is selected from solvents that are able to solubilize polymer (A) but not the sulfide-based solid electrolyte.

The solvent (S) is substantially water free, the water content being preferably 100 ppm or less. The sulfide-based solid electrolyte may in fact react with water to generate hydrogen sulfide, which is toxic and harmful and may lower the ion conductivity of the electrolyte or attack the components of the battery.

The (per)fluorinated solvents (S) suitable for use in the present invention are preferably selected from (per)fluoropolyethers having chemical formula different from the chemical formula of polymer (A) (such as, those commercially available from Solvay Specialty Polymers Italy S.p.A. under the trade name Galden®), perfuoroalkanes (such as, perfuorohexane, perfuoroheptane and the like), hydrofluoroethers, and mixtures thereof.

The solvent plays a role in uniformly dissolving the polymer (A).

It is preferable that the amount of the at least one solvent (S) in composition (C) is 35-90 wt % when the total mass of the composition (C) is 100 wt %. If the amount of the solvent is less than 35% by mass, the content ratio of the solvent or the like is too small, the (per)fluorinated amorphous polymer does not dissolve in the solvent. On the other hand, if the amount of the solvent exceeds 90 wt %, processing the composition (C) into a film may be difficult because the content ratio of the solvent is too large. The amount of the at least one solvent (S) in composition (C) is more preferably from 40 to 80 wt %.

The skilled in the art, depending on the boiling point of the at least one solvent (S), will select the proper amount of said solvent (S) in composition (C) in order to achieve dissolution of the (per)fluorinated amorphous polymer [polymer (A)] and suitable evaporation of the same when composition (C) is used in the process for manufacturing a solid electrolyte film or an electrode for solid state batteries.

Composition (C) can be suitably prepared by a process comprising mixing polymer (A), the sulfide-based solid electrolyte material and solvent (S) by any method known to the skilled in the art. In a preferred embodiment, composition (C) is prepared by a process comprising solubilizing polymer (A) in solvent (S) followed by adding the sulfide-based solid electrolyte material and mixing the resulting mixture.

The amount of polymer (A) in composition (C) is such to provide a composite solid electrolyte film including polymer (A) in an amount preferably ranging from 2 to 30 wt %, preferably from 4 and 25 wt %, more preferably from 5 to 20 wt % with respect to the total weight of polymer (A) and sulfide-based solid electrolyte material.

If the amount of the polymer (A) is less than 2 wt %, cohesion of the sulfide-based solid electrolyte material in the composite solid electrolyte film would be insufficient. On the other hand, if the amount of polymer (A) exceeds 30 wt %, ionic conductivity the composite solid electrolyte film is affected.

In another object, the present invention is directed to a process for manufacturing a composite solid electrolyte film for solid state batteries comprising the steps of:

I) processing the composition (C) as above defined to form a wet film of a composite solid composite electrolyte;

II) drying the wet film provided in step (I).

In step (I) of the process of the invention, the composition (C) is typically applied onto at least one foil of inert flexible support by a technique selected from casting, spray coating, rotating spray coating, roll coating, doctor blading, slot die coating, gravure coating, ink jet printing, spin coating and screen printing, brush, squeegee, foam applicator, curtain coating, vacuum coating, casting being the preferred one.

The wet film so obtained typically has a thickness comprised between 10 μm and 400 μm, preferably between 50 μm and 400 μm.

In step (II) of the process of the invention, the composition (C) is dried at a temperature preferably comprised between 10° C. and 100° C., preferably between 20° C. and 80° C.

An additional drying step in a oven under vacuum at a temperature preferably comprised between 20° C. and 100° C., preferably between 30° C. and 50° C. can be suitably carried out to achieve complete solvent removal.

The skilled in the art, depending on the boiling point of the at least one solvent (S), will select the proper duration and temperature of the drying step (II) of the process.

The dry film obtained in step (II) of the process typically has a thickness comprised between 10 μm and 150 μm.

The process of the invention for preparing a composite solid electrolyte film may further include an additional step (III) of subjecting the dry film provided in step (II) to a compression step, such as a calendering or uniaxial compression process, to lower the porosity and increase the density of the composite solid electrolyte film.

Composition (C) is also suitable for use in the preparation of electrodes for solid state batteries.

A further object of the invention is thus a process for manufacturing an electrode for solid state battery comprising the steps of:
A) providing an electrode-forming composition comprising:
   a composition (C) as above defined;
   at least one electrode active material (AM); and
   optionally, at least one electrical conductive additive;
B) providing a metal substrate having at least one surface;
C) applying the electrode-forming composition provided in step A) onto the at least one surface of the metal substrate provided in step B), thereby providing an assembly comprising a metal substrate coated with said composition (C) onto the at least one surface; and
D) drying the assembly provided in step C).

An electrode-forming composition to be used in step (A) of the process may be obtained by adding and dispersing a powdery electrode active substance, and optional additives, such as an electroconductivity-imparting additive and/or a viscosity modifying agent, into the composition (C) of the present invention.

In the case of forming a positive electrode, the active substance may be selected from the group consisting of a composite metal chalcogenide represented by a general formula of LiMY2, wherein M denotes at least one species of transition metals such as Co, Ni, Fe, Mn, Cr, Al and V; and Y denotes a chalcogen, such as O or S. Among these, it is preferred to use a lithium-based composite metal oxide represented by a general formula of LiMO2, wherein M is the same as above. Preferred examples thereof may include: LiCoO₂, LiNiO₂, LiNiₓCo₁₋ₓO₂ (0<x<1), Lix (Ni_{0.8}Co_{0.15}Al_{0.05}) )₂Li(Ni_{1/3}Co_{1/3}Mn_{1/3}))₂; Li(Ni_{0.6}Co_{0.2}Mn_{0.2})O₂, Li(Ni_{0.8}Co_{0.1}Mn_{0.1})O₂ and spinel-structured LiMn₂O₄ and LiMn_{1.5}Ni_{0.5}O₄. These active materials may be coated with inorganic or organic coatings, such as LiNbO₃.

As an alternative, still in the case of forming a positive electrode, the active substance may comprise a lithiated or partially lithiated transition metal oxyanion-based electrode materials of the nominal formula AB(XO₄)_{f}E_{1-f}, in which A is lithium, which may be partially substituted by another alkali metal representing less that 20% of the A metals, B is a main redox transition metal at the oxidation level of +2 chosen among Fe, Mn, Ni or mixtures thereof, which may be partially substituted by one or more additional metal at oxidation levels between +1 and +5 and representing less than 35% of the main +2 redox metals, including 0, XO₄ is any oxyanion in which X is either P, S, V, Si, Nb, Mo or a combination thereof, E is a fluoride, hydroxide or chloride anion, f is the molar fraction of XO₄ oxyanion, generally comprised between 0.75 and 1.

The active substance for use in forming a positive electrode can also be sulfur or Li₂S.

In the case of forming a negative electrode, the active substance may preferably comprise a carbon-based material and/or a silicon-based material.

In some embodiments, the carbon-based material may be, for example, graphite, such as natural or artificial graphite, graphene, or carbon black.

These materials may be used alone or as a mixture of two or more thereof.

The carbon-based material is preferably graphite.

The carbonaceous material may preferably be used in the form of particles having an average diameter of ca. 0.5 - 100 μm.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

When present, the at least one silicon-based compound is comprised in the active substance in an amount ranging from 1 to 30% by weight, preferably from 5 to 10% by weight with respect to the total weight of the active substance.

An electroconductivity-imparting additive may be added in order to improve the conductivity of a resultant composite electrode film formed by applying and drying of the electrode-forming composition of the present invention, particularly in case of using an active substance, such as LiCoO₂ or LiFePO₄, showing a limited electron-conductivity. Examples thereof may include: carbonaceous materials, such as carbon black, graphite fine powder and fiber, and fine powder and fiber of metals, such as nickel and aluminum.

The present invention also provides an electrode for a solid state battery obtainable by the process as above defined.

In a further object, the present invention provides a solid state battery comprising a composite solid electrolyte film as above defined.

The solid state battery of the invention includes a positive electrode and a negative electrode,

wherein preferably at least one of the negative electrode or the positive electrode is an electrode according to the invention.

Should the disclosure of any patents, patent applications, and publications which are incorporated herein by reference conflict with the description of the present application to the extent that it may render a term unclear, the present description shall take precedence.

The invention is described hereunder in more detail with reference to the following examples, which are provided with the purpose of merely illustrating the invention, with no intention to limit its scope.

### Experimental Section

Materials and Methods

LSPS (Li₁₀SnP₂S₁₂), commercially available under the trademark name NANOMYTE® SSE-10 from NEI Corporation

LPSCI (Li₆PS₅CI), commercially available from NEI Corporation

Hyflon® AD-60, commercially available from Solvay Specialty Polymers Italy S.p.A.

Hyflon® 40 L, commercially available from Solvay Specialty Polymers Italy S.p.A.

Hyflon® 40 H, commercially available from Solvay Specialty Polymers Italy S.p.A.

Tecnoflon® PFR 91 commercially available from Solvay Specialty Polymers Italy S.p.A.

Teflon® AF 1600, commercially available from Dupont.

Ethoxy-nonafluorobutane (C₄F₉OC₂H₅), commercially available under the trademark name Novec® 7200 from 3M

Galden® DO2TS, commercially available from Solvay Specialty Polymers Italy S.p.A.

Thermoplastic styrenic elastomer commercially available under the trademark name Tuftec® N504 from Asahi Kasei Chemicals Corporation

### Example 1: LSPS- Hyflon® AD-60 composite film

In an Ar filled glove box 0.3 g of Hyflon® AD-60 were dissolved in 8 g of Novec® 7200. 3.0 g of LSPS were added to this solution and the resulting dispersion was cast on a flexible inert support (ECTFE film). The film was dried at room temperature followed by vacuum drying at 40 ° C. overnight. The dried film was removed from the support in order to obtain a free standing film.

### Examples 2-4: LSPS- Hyflon® AD-60 composite film

The same procedure of Example 1 was followed, varying the amounts of LSPS and Hyflon® AD-60 and Novec® 7200 to obtain electrolyte films with different amounts of Hyflon® AD-60 polymer.

### Examples 5-10:

The same procedure of Example 1 was followed for Examples 5-10 but the type of amorphous perfluorinated polymer was changed. Example 5 was carried out with Hyflon® 40 L, Example 6 with Hyflon® 40 H, Example 7 with Teflon® AF 1600, Examples 8 to 10 with with Tecnoflon® PFR 91.

### Example 11

The same procedure of Example 1 was followed, except that Galden® DO2TS was used instead of Novec® 7200. The mixture before casting had higher viscosity than those of Examples 1 to 10.

The film obtained after drying showed improved flexibility in comparison with the films obtained in Examples 1 to 10.

### Example 12

In an Ar filled glove box 0.3 g of Hyflon® AD-60 were dissolved in 8 g of Novec® 7200. 3.0 g of LPSCI were added to this solution and the resulting dispersion was cast on a flexible inert support (ECTFE film). The film was dried at room temperature followed by vacuum drying at 40 ° C. overnight. The dried film was removed from the support in order to obtain a free standing film.

### Example 13

The same procedure of Example 12 was followed, except that the amounts of LPSCI, Hyflon® AD-60 and Novec® 7200 were adapted in order to obtain an electrolyte film with a higher amounts of Hyflon® AD-60

The compositions of the films obtained in Examples 1-13 are shown in Table 1.

### Comparative Example 1

0.1 g of Tuftec® N504 were dissolved in 2.5 g of xylene. 3.233 g of LSPS were added to this solution and the resulting dispersion was cast on a flexible inert Teflon support. The film was dried at 50° C. followed by vacuum drying at 80 ° C. overnight. The dried film was removed from the support in order to obtain a free standing film.

The composition of the film obtained in Comparative Example 1 is shown in Table 1.

### Comparative Examples 2-6

The same procedure of Comparative Example 1 was followed, except that the amount of LSPS was adapted to obtain the films as detailed in Table 1.

Measurement of ionic conductivity under pressure

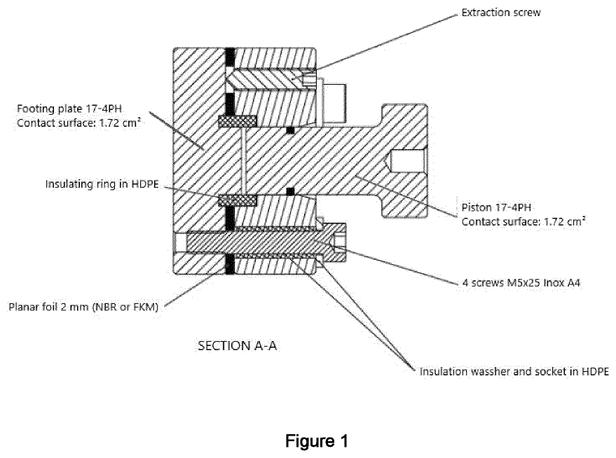

The ionic conductivity of the films obtained in Examples 1-11 and in Comparative Examples 1-6 were measured by AC impedance spectroscopy with an in house developed pressure cell, where the film is pressed between 2 stainless steel electrodes during impedance measurements. A cross section of the pressure cell used for the measurement is shown in FIG. 1. The impedance spectra were determined at a pressure of 83 MPa and a temperature of 20° C. The resistance R of the solid composite electrolyte was obtained by extrapolating the linear part of the low frequency diffusion tail of the impedance spectra. Accordingly the ionic conductivity a was obtained using the equation of σ=d/(R×A), wherein d is the thickness of the film and A is the area of the stainless steel electrode.

The ionic conductivity of the electrolyte films of the examples are shown in Table 1.

TABLE 1

| | | | | | Conduc- |
|---|---|---|---|---|---|
| | Sulfide | Polymer | | | tivity |
| Sample | type | type | wt % | vol % | (mS/cm) |
| Example 1 | LSPS | Hyflon ® AD-60 | 9.1 | 10.5 | 0.52 |
| Example 2 | LSPS | Hyflon ® AD-60 | 4.8 | 5.5 | 0.80 |
| Example 3 | LSPS | Hyflon ® AD-60 | 11.8 | 13.5 | 0.36 |
| Example 4 | LSPS | Hyflon ® AD-60 | 16.7 | 18.9 | 0.21 |
| Example 5 | LSPS | Hyflon ® 40 L | 9.1 | 10.5 | 0.50 |
| Example 6 | LSPS | Hyflon ® 40 H | 9.1 | 10.5 | 0.55 |
| Example 7 | LSPS | Teflon ® AF 1600 | 9.1 | 10.5 | 0.47 |
| Example 8 | LSPS | Tecnoflon ® PFR 91 | 9.1 | 10.1 | 0.47 |
| Example 9 | LSPS | Tecnoflon ® PFR 91 | 10.9 | 12.1 | 0.54 |
| Example 10 | LSPS | Tecnoflon ® PFR 91 | 11.8 | 13.1 | 0.43 |
| Example 11 | LSPS | Hyflon ® AD-60 | 9.1 | 10.5 | 0.49 |
| Example 12 | LSPCI | Hyflon ® AD-60 | 16.7 | 16.2 | 0.36 |
| Example 13 | LSPCI | Hyflon ® AD-60 | 9.1 | 8.8 | 0.51 |
| Comp. | LSPS | Tuftec ® N504 | 1 | 2.5 | 0.67 |
| example 1 | | | | | |
| Comp. | LSPS | Tuftec ® N504 | 2 | 4.9 | 0.49 |
| example 2 | | | | | |
| Comp. | LSPS | Tuftec ® N504 | 3 | 7.2 | 0.39 |
| example 3 | | | | | |
| Comp. | LSPS | Tuftec ® N504 | 4 | 9.4 | 0.23 |
| example 4 | | | | | |
| Comp. | LSPS | Tuftec ® N504 | 5 | 11.6 | 0.19 |
| example 5 | | | | | |
| Comp. | LSPS | Tuftec ® N504 | 10 | 21.8 | 0.06 |
| example 6 | | | | | |

The results demonstrate that the composite solid electrolytes of the present invention show a high ionic conductivity even at high amount of binder, while in the presence of the polymer binder of the prior art the ionic conductivity decreases significantly at the binder content increase.

The compositions of the present invention thus allow obtaining composite solid electrolytes having improved mechanical properties in comparison with the solid electrolytes of the prior art while keeping a surprisingly high ionic conductivity.

1-14. (canceled)

15. A composite solid electrolyte film for solid state batteries comprising:
i) at least one sulfide-based solid electrolyte; and
ii) at least one (per)fluorinated amorphous polymer [polymer (A)].

16. The composite solid electrolyte film according to claim 15 wherein the at least one sulfide-based solid electrolyte is selected from the group consisting of:
lithium tin phosphorus sulfide (“LSPS”) materials;
lithium phosphorus sulfide (“LPS”) materials;
doped LPS;
lithium phosphorus sulfide oxygen (“LPSO”) materials of formula LixPySzO, where 0.33≤x≤0.67, 0.07≤y≤0.2, 0.4≤z≤0.55, 0≤w≤0.15;
lithium phosphorus sulfide materials including X (“LXPS”), wherein X is Si, Ge, Sn, As, Al;
lithium phosphorus sulfide oxygen including X (“LXPSO”), wherein X is Si, Ge, Sn, As, Al;
lithium silicon sulfide (“LSS”) materials;
lithium boron sulfide materials;
lithium tin sulfide materials and lithium arsenide materials; and
Argyrodite-type sulfide materials of formula Li₆PS₅Y, wherein Y is Cl, Br or I , the compounds optionally being deficient in sulfur, lithium or halogen or doped with a heteroatom.

17. The composite solid electrolyte film according to claim 15 wherein the at least one (per)fluorinated amorphous polymer [polymer (A)] is selected from the group consisting of:
polymers (A-1) comprising recurring units derived from:
perfluorodioxoles of formula (I): 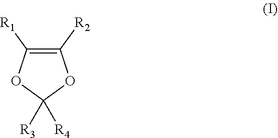
wherein R₁, R₂, R₃ and R₄, equal to or different from each other, are independently selected from the group consisting of —F, a C₁-C₆ fluoroalkyl group, optionally comprising one or more oxygen atoms;
at least one fluorinated monomer selected from the group consisting of:
C₂-C₈ perfluoroolefins;
C₂-C₈ hydrogenated fluoroolefins; and
chloro- and/or bromo- and/or iodo-C₂-C₆ fluoroolefins;
polymers (A-2) comprising recurring units derived from:
C₂-C₈ perfluoroolefins;
at least one fluorinated monomer selected from the group consisting of:
perfluoroalkylvinylethers of formula CF₂=CFOR_{f1′} wherein R_{f1′} is a C₁-C₆ perfluoroalkyl group;
perfluoro-oxyalkylvinylethers of formula CF₂=CFOX₀ wherein X₀ is a C₁-C₁₂ perfluorooxyalkyl group comprising one or more ether groups; and
optionally, recurring units derived from C₂-C₈ hydrogenated fluoroolefins;
polymers (A-3) comprising recurring units derived from at least one cyclopolymerizable monomer of formula
CR₅R₆=CR₇OCR₈R₉(CRₗₒR₁₁)ₐ(O)_{b}CR₁₂=CR₁₃R₁₄, wherein each R₅ to R₁₄, independently of one another, is selected from —F and a C₁-C₃ fluoroalkyl group, a is 0 or 1, b is 0 or 1 with the proviso that b is 0 when a is 1;
polymers (A-4) comprising:
recurring units derived from C₂-C₈ perfluoroolefins; and
recurring units derived from C₂-C₈ hydrogenated fluoroolefins.

18. The composite solid electrolyte film according to claim 17 wherein polymer (A-1) comprises recurring units derived from at least one perfluorodioxole of formula (I) wherein R₁=R₃=R₄=—F and R₂=—OCF₃ or wherein R₁=R₂=—F and R₃=R₄=—CF₃ and recurring units derived from tetrafluoroethylene (TFE).

19. The composite solid electrolyte film according to claim 17 wherein polymer (A-2) comprises recurring units derived from tetrafluoroethylene (TFE), recurring units derived from perfluoromethylvinylether of formula CF₂=CFOCF₃, and recurring units derived from vinylidene fluoride (VDF).

20. The composite solid electrolyte film according to claim 17 wherein polymer (A-4) comprises recurring units derived from vinylidene fluoride (VDF) and recurring units derived from hexafluoropropene (HFP).

21. A composition (C) suitable for preparing the composite solid electrolyte film according to claim 15, said composition comprising:
i) at least one sulfide-based solid electrolyte;
ii) at least one (per)fluorinated amorphous polymer [polymer (A)]; and
iii) at least one (per)fluorinated solvent (S).

22. The composition (C) according to claim 21 wherein the at least one (per)fluorinated solvent (S) is selected from (per)fluoropolyethers, perfuoroalkanes, hydrofluoroethers, and mixtures thereof.

23. A process for manufacturing a composite solid electrolyte film for solid state batteries comprising the steps of:
I) processing the composition (C) according to claim 21 to form a wet film of a solid composite electrolyte; and
II) drying the wet film provided in step (I).

24. The process according to claim 23 which further includes a step (III) of subjecting the dry film provided in step (II) to a compression step.

25. A process for manufacturing an electrode for solid state battery comprising the steps of:
A) providing an electrode-forming composition comprising:
a composition (C) according to claim 21;
at least one electrode active material (AM); and
- optionally, at least one electrical conductive additive;
B) providing a metal substrate having at least one surface;
C) applying the electrode-forming composition provided in step A) onto the at least one surface of the metal substrate provided in step B), thereby providing an assembly comprising a metal substrate coated with said composition (C) onto the at least one surface;
D) drying the assembly provided in step C).

26. An electrode for a solid state battery obtainable by the process according to claim 25.

27. A solid state battery comprising the composite solid electrolyte film according to claim 15.

28. The solid state battery comprising:
a positive electrode and a negative electrode,
wherein at least one of the negative electrode or the positive electrode is an electrode according to claim 26.
